(19) United States
(12) Patent Application Publication
(10) Pub. No.: US 2014/0299351 A1
(43) Pub. Date: Oct. 9, 2014

(54) CONTACT ELEMENT AND METHOD FOR THE PRODUCTION THEREOF

(71) Applicant: Robert Bosch GmbH, Stuttgart (DE)

(72) Inventors: Manfred Moser, Reutlingen (DE); Richard Gueckel, Schwieberdingen (DE); Stefan Rysy, Stuttgart (DE); Erik Biehl, Boeblingen (DE)

(21) Appl. No.: 14/364,397

(22) PCT Filed: Oct. 19, 2012
(86) PCT No.: PCT/EP2012/070763

§ 371 Date: Jun. 11, 2014

(30) Foreign Application Priority Data
Dec. 12, 2011 (DE) 10 2011 088 211.1

(51) Int. Cl. H01B 7/00; H01B 1/02; C25D 3/56

(52) U.S. Cl. CPC H01B 7/0009; C25D 3/56; H01B 1/02; H01B 1/023; H01B 1/026
USPC 174/110 SR; 205/252; 205/254

(57) ABSTRACT

The invention relates to a contact element for a solder-free electrical connection. The contact element has at least one contact section that is designed to produce an electrical contact, in particular by means of insulation displacement terminations and/or a spring contact and/or crimping and/or riveting and/or screwing and/or caulking and/or folding and/or bending of a stamped grid. The invention also relates to a stannous surface coating that covers the contact element at least in sections. In order to provide a contact element having a lead-free surface coating that prevents whisker growth or minimizes such growth to a large extent, the surface coating contains between 15 and 73 mass percent of silver.

### BACKGROUND OF THE INVENTION

The invention relates to a contact element and a method for the production of a contact element.

Permanent, solder-free electric contacts are becoming more widely used in the field of mounting and joining technologies. Lead-free surface coatings which consist of pure tin and are produced galvanically or by means of hot dip tinning are known from the prior art.

In known joining technologies, such as crimping or flanging, spring contacts, rivet contacts, screw contacts, caulking, folding and bending of stamped grids and/or extrusion-coating of metal parts with plastic, very high surface pressures and layer stresses on or into the pure tin surfaces result from the contact forces and/or bending forces which arise. Due to these high stresses, the phenomenon of whisker formation occurs with galvanically applied pure tin surfaces. Whiskers are tin monocrystals which grow out of the coating and can become up to several millimeters in length. Said whisker formation can lead to short circuits in electrical connections. Whiskers often form only after years of operation, and a short circuit caused by a whisker occurs without warning. Whisker formation is, for example, frequently responsible for the sudden breakdown of the electronics of a motor vehicle.

A press-fit contact is known from the American patent specification US 2009/0239398 A1, on which contact a tin-silver layer having a silver content of 0.5 to 15 percent by mass is applied in order to prevent whiskers. Different methods are proposed as to how said layer can be applied, electroplating is mentioned among other things. It has become clear that a layer applied galvanically, as said layer is described in the American patent specification US 2009/0239398 A1, does in fact display a reduced whisker growth when compared to a pure tin coating; however, the whisker growth is still unacceptably high for many applications, in particular in the automotive field.

### SUMMARY OF THE INVENTION

The invention is based on the recognition that surfaces consisting of pure tin or surfaces consisting of tin with a small silver content represent a high risk with regard to whisker formation when the surfaces are subjected to a mechanical stress. It is therefore the aim of the invention to minimize the risk of whisker formation on contact elements, as said elements are used in a motor vehicle. This aim is met by means of the galvanic surface coating according to the invention.

In contrast to known galvanic tin-silver (SnAg) coatings, the inventive surface coating is characterized by a very high silver content in the tin-silver alloy of between 15 and 73 percent by mass. The silver content amounts preferably to at least 30 per cent by mass, particularly preferred between 45 and 60 percent by mass. Contact elements having the inventive surface coating show a significantly reduced whisker growth in comparison to conventional coatings.

The inventive surface coating is used in joining methods which include insulation displacement terminations, spring contacts, stake contacts, crimp connections, flanging, caulking, folding and bending of a stamped grids or is used when completely or partially extrusion-coating the metal contact elements with plastic. In all of the aforementioned joining methods, contact elements are, for example, used to establish an electrical contact between an electrical circuit on a printed circuit board and a contact wire.

Common to all of said different contact methods is that, with regard to contact elements used in each case, very high surface pressures act on or in the surface of the contact element due to the contact forces or bending forces. The risk of whiskers forming is particularly high in the regions of high mechanical stress. The formation of whiskers is effectively prevented by the inventive surface coating comprising a tin-silver alloy that has a silver content of 15 to 73 percent by mass of the contact elements, said surface coating being at least provided in the regions in which the mechanical stress or surface pressure of the contact element is comparatively large.

A further advantage of the surface coating according to the invention is that it is possible to optimize the contact resistances and the current carrying capacity of the electrical contact by means of the addition of a dosable proportion of silver as an alloying element. In so doing, the following applies: the higher the proportion of silver in the surface coating, the better the conductivity and current carrying capacity of the electrical contact. This is particularly advantageous in the case of plug contacts. In addition, the manipulation of the surface hardness and thus the targeted adjustment of insertion forces as well as the sliding properties are possible by means of the selection of the proportion of silver in the surface coating. Moreover, the targeted adjustment of the resistance to wear is therefore also possible. In so doing, the following applies: the higher the proportion of silver, the harder and more wear resistant is the surface of the contact element. A higher proportion of tin in the surface coating produces a certain solid lubrication and thus reduces the insertion forces. By selecting the proportion of silver or tin in the surface coating to fit the application, the fretting corrosion occurring with changes in temperature and/or mechanical stresses, which occur as a result of vibrations in the plug connector region, can be reduced.

Provision is made for at least regions of the respective contact element to be furnished with the inventive surface coating consisting of a tin-silver alloy. It is also possible to completely coat the surface of the contact element or coat the same to the greatest possible extent. It is preferred to provide the surface coating at least in the regions in which, after the electrical contact has been established, the greatest mechanical stresses on the surface of the respective contact element are expected.

A contact element according to the invention which is designed as an insulation displacement element comprises in a known manner a wire receptacle which is designed to contact a longitudinal section of a contact wire in an incisive and/or press-fitting manner and hold the same securely during insertion into the wire receptacle. The region of the wire receptacle of the insulation displacement element is subjected to high mechanical stresses generated by the deformation. The inventive surface coating, which comprises a tin-silver alloy having a silver content of 15 to 73 percent by mass, is therefore preferably provided at least in the region of the wire receptacle of the insulation displacement element in order to prevent whiskers from forming.

An inventive contact element which is designed to produce an electrical contact by crimping or flanging comprises regions that are plastically deformed, said regions thereby being pressed into a mating contact, such as, e.g., a wire and thereby producing an undetachable electrical contact. According to the invention, provision is made in the case of such a contact element for a surface coating which comprises a tin-silver alloy having a silver content of 15 to 73 percent by mass at least in the regions in which high surface pressures arise as a result of the plastic deformation.

In the case of an inventive contact element which has a spring contact, the regions which are designed to press resiliently against the mating contact and thus achieve an electrical contacting are subjected to high mechanical stresses. That is why such a contact element has the inventive surface coating preferably in the aforementioned resilient contact regions.

Contact elements which are designed as screws or rivets are preferably completely provided with the surface coating according to the invention.

The contact element preferably consists substantially of copper, iron or aluminum or an alloy which comprises at least one of these metals as an essential component. In a preferred embodiment, the contact element is designed as a stamped grid. In this context, a contact element is understood which is formed from a metal sheet by stamping. It is preferably configured to produce an electrical contact by folding and/or bending of the stamped grid. The contact element is subjected to high mechanical stresses in the aforementioned regions. That is why the inventive surface coating comprising a tin-silver alloy having a silver content of 15 to 73 percent by mass is preferably used there.

In a preferred embodiment, the contact element is at least partially extrusion coated with plastic, for instance in order to constitute a plug part or to protect the contact element. By eztrusion coating with plastic, forces can be exerted on the contact element, for example due to the different expansion behaviors when a temperature change occurs, said forces leading to high mechanical stresses and hence to an increased risk of whiskers forming. For that reason, a surface coating which comprises a tin-silver alloy having a silver content of 15 to 73 percent by mass is provided according to the invention.

In a particularly preferred embodiment of the invention, the contact element can be at least partially nickel plated prior to the deposition of the tin-silver surface coating. Said contact element can thus have a cover coat consisting of nickel or a nickel layer, on which the inventive tin-silver surface coating is applied. The surface properties with regard to hardness and abrasion resistance are improved by the nickel layer. Furthermore, the contact element is protected from corrosion in this manner.

In order to protect and/or improve the sliding properties, the SnAg surface coating can be covered by a protective layer which comprises a grease or a lubricant. Said protective layer furthermore effects a passivation of the tin-silver surface coating. Thiol, paraffin or a contact oil, such as, e.g., Optimol®, are, for example, worth considering as possible materials for the protective layer.

The surface coating consisting of tin-silver is preferably galvanically deposited, in particular from an acidic or highly acidic, galvanic tin-silver alloy electrolyte, on the contact element. The galvanic coating has the advantage that a fine crystalline and uniform alloy of tin and silver results. The coating preferably has a thickness between 0.1 μm and 12 μm, in particular preferably between 0.20 and 1.8 μm.

The galvanic coating preferably takes place in a continuous flow system (strip electroplating facility) comprising a plurality of cells. The contact element is thereby guided through cells disposed in a row, wherein the cells are filled with methanesulfonic acid, in which tin ions and silver ions are dissolved, and wherein the cell contents are circulated in the cell during electroplating.

The contact element in the cells is preferably subjected to the flow of methanesulfonic acid, in which tin ions and silver ions are dissolved, by means of nozzles that are disposed within the cells. In so doing, it is ensured that even contact elements having complicated geometries can be reliably coated.

The coating in such a strip electroplating facility is particularly advantageous if the contact element is present as a stamped grid component. The contact element is preferably moved through the cell as part of a strip-shaped stamped grid. After the strip-shaped stamped grid has passed through the strip electroplating facility, the individual contact elements can be separated. As a result, the handling is simplified.

The inventive coating of contact elements can also alternatively take place by means of a so-called bulk material plating, also referred to as barrel plating. The cell is constructed barrel-like and filled with methanesulfonic acid in which tin and silver ions are dissolved. The barrel is filled with the components to be coated and slowly rotates. This coating process is particularly suited to contact elements which are not present as a stamped grid, such as, for example, screws or rivets.

In addition, a reflow or temperature treatment of the contact element can be carried out in a known manner after or prior to galvanic coating, whereby, if required, the surface properties are further improved or adapted to the application.

### BRIEF DESCRIPTION OF THE DRAWINGS

The invention will now be described in detail with the aid of a plurality of exemplary embodiments which refer to the figures.

FIG. 1 shows an inventive contact element for connecting a connecting wire to a contact pin.

FIG. 2 shows a crimp connection in a spatial view as well as in cross section.

FIG. 3 shows an inventive contact element for an insulation displacement connection.

FIG. 4 shows a schematic depiction of a cell of a strip electroplating facility.

### DETAILED DESCRIPTION

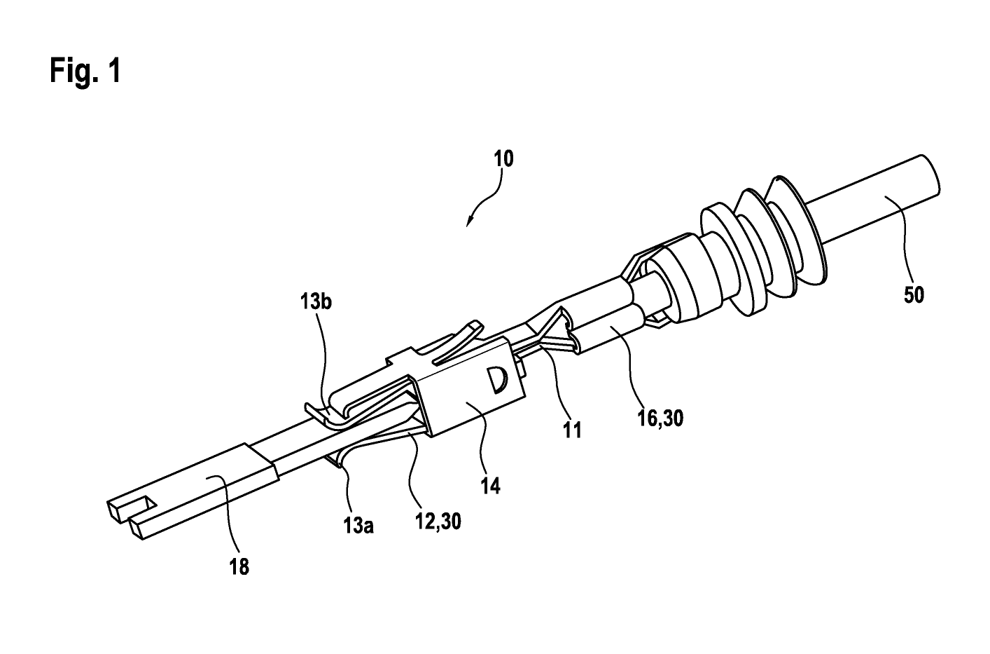

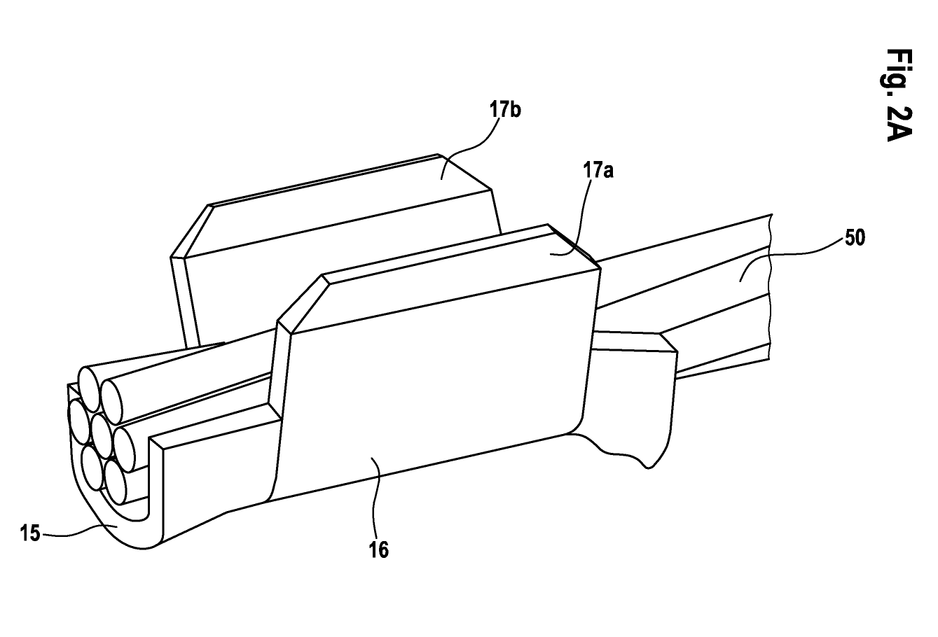

FIG. 1 depicts a contact element 10 according to the invention which produces an electrical contact between a contact pin 18 that is designed as a blade contact and a connecting wire 50 that is designed as a stranded wire. The contact element comprises a first section that is designed as a spring contact 12 having two limbs 13a and 13b. In order to establish the contact, the tip of the contact pin 18 is pushed between the limbs 13a and 13b. The limbs 13a and 13b are thereby bent apart and elastically and/or plastically deformed. In so doing, the limbs 13a and 13b push from two sides against the contact pin 18, hold the same securely and establish an electrical contact. In order to permanently provide the contact pressure, a separate component 14 made of stainless steel is provided in this example, which is fit over the spring contact 12 in a clamp-like manner and exerts pressure against the limbs 13a and 13b.

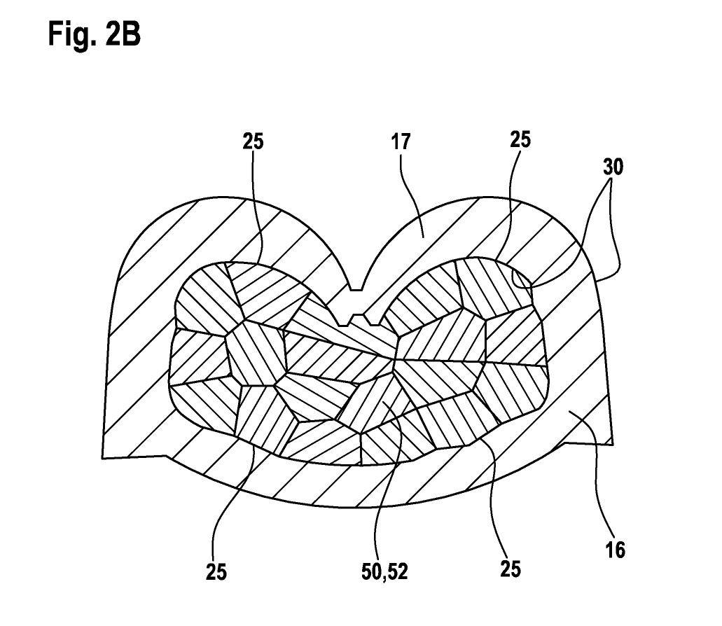

The contact element 10 comprises a second section which is designed as a crimp contact 16. The first section and the second section are connected by means of an intermediate section 11. To this end and as is depicted in detail in FIG. 2A, said intermediate section comprises a wire receptacle 15 having a substantially U-shaped cross section in which a wire 50 is inserted. The section 16 comprises two aliform extensions 17a and 17b. The extensions 17a and 17b are beveled in a blade-like manner at the free ends thereof. In order to establish the electrical contact, the extensions 17a and 17b are bent using a suitable tool and cut into the wire 50 with the free ends thereof.

As is shown in FIG. 2b which depicts a cross section through the crimp contact 16, the wire which consists of individual strands is pressed together in the process. As a result, a very high surface pressure acts in the crimp contact 16, particularly in the regions 25.

In order to achieve a reliable, lead-free and gas-tight electrical connection and at the same time minimize the risk of whiskers forming, the contact element 10 is provided with a surface coating at least in the sections 12 and 16. The thickness of said coating is in this example between 0.25 and 0.6 μm. In the exemplary embodiment depicted, the coating consists of a tin-silver alloy having a silver content of more than 30 percent by mass, preferably between 40 and 55 percent by mass.

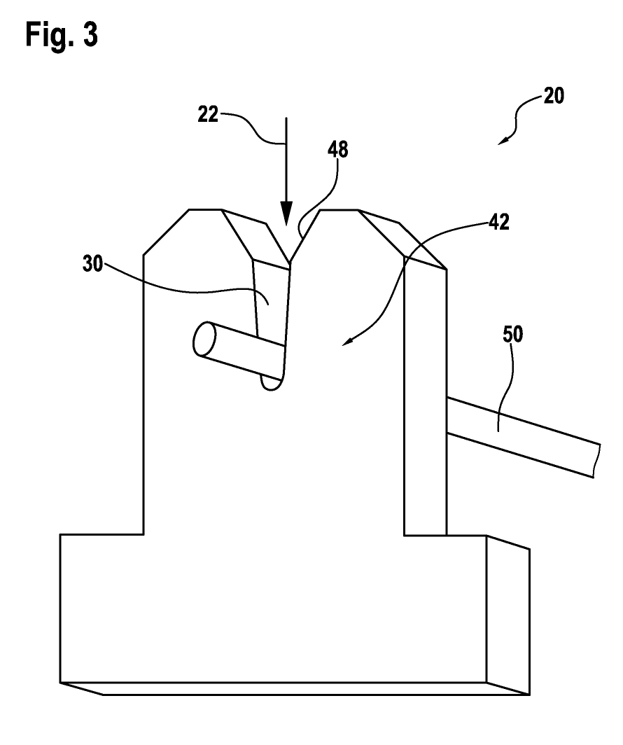

FIG. 3 depicts a contact element 20 for an insulation displacement contact 42. The contact element 20 comprises a wire receptacle 48 which is designed to contact a longitudinal section of a contact wire 50 in an incisive or press-fitting manner and hold the same securely during insertion into the wire receptacle 48. The wire is thereby press-fitted in the direction indicated by the arrow 22. A wire receptacle 48 is designed as a solid or elastic, V-shaped notch and is also referred to as an insulation displacement termination. Said insulation displacement termination 48 and the wire 50 plastically and elastically deform when the wire 50 is pressed into the V-shaped notch of the insulation displacement termination 48 and fit together with regard to the contour thereof. In this way, the wire 50 directly contacts the insulation displacement termination 48. Due to the deformation, the region of the insulation displacement termination 48 is subjected to high mechanical stresses. A surface coating 30 consisting of a tin-silver alloy that has a silver content of preferably 55 to 60 percent by mass is provided in the region of the insulation displacement termination 48.

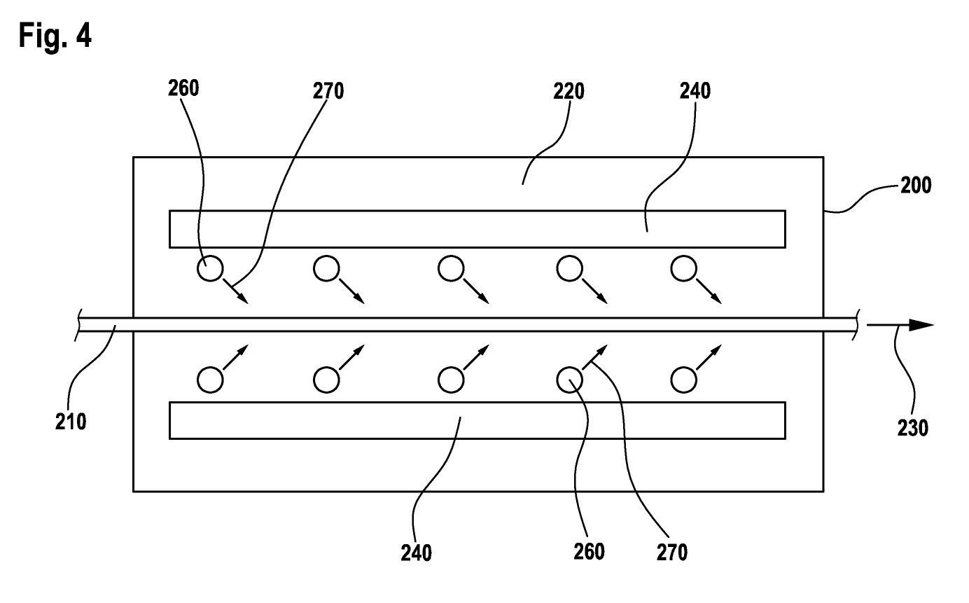

As is depicted in FIG. 4, the application of the surface coating of a contact element designed according to the invention can take place in a strip electroplating facility. In so doing, a strip-shaped stamped grid, in which the contact elements are held in a not yet completely punched-out condition, is moved through a plurality of cells 200 located one behind the other. FIG. 4 schematically depicts such a cell in a top view. The strip-shaped stamped grid (not depicted) is moved on a conveyor belt 210 in the direction of transportation 230 through the cell 200. An electrolyte is located in the cell 220. In this example, the electrolyte 220 is an aqueous methanesulfonic acid, in which the tin and silver ions are dissolved. The electrolyte is pumped in a circuit within the cell, wherein the feed into the cell takes place via nozzles 260 which are directed towards the conveyor belt but obliquely in the direction of the direction of movement of the belt 210, as is depicted by the arrows 270.

A suitable material for the plate-shaped anodes is pure tin. The silver ions are preferably in liquid and/or dissolved form. The tin ions are preferably added in the form of tin methanesulfonate and/or by means of the solubility of the tin anodes. The composition of the tin-silver surface coating arising in this manner depends on the concentration of the silver and tin ions as well as on the current density. According to the invention, the operating parameters are adjusted in such a way that a surface coating results which has a silver content of 15 to 73 percent by mass.

1. A contact element (10, 20) for a solder-free electrical connection, which element has at least one contact section (12, 16, 18) that is designed to produce an electrical contact, wherein the contact element (10,20) has a stannous surface coating (30) at least in sections, characterized in that the surface coating (30) has 15 to 73 mass percent of silver.

2. The contact element according to claim 1, characterized in that the contact element is at least partially enclosed by an overmold consisting of plastic.

3. The contact element according to claim 1, characterized in that the surface coating (30) is galvanically deposited on the contact element.

4. The contact element according to claim 1, characterized in that the surface coating (30) has between 30 and 65 mass percent of silver.

5. The contact element according to claim 4, characterized in that the surface coating (30) has between 40 and 60 mass percent of silver.

6. The contact element according to claim 1, characterized in that the surface coating (30) has a thickness of at least 0.1 μm and at most 12 μm.

7. The contact element according to claim 6, characterized in that the surface coating (30) has a thickness between 0.2 μm and 1.8 μm.

8. The contact element according to claim 1, characterized in that the contact element is formed substantially from copper or iron or aluminum or an alloy which comprises copper or iron or aluminum as the essential component.

9. The contact element according to claim 1, characterized in that the contact element is embodied as a stamped grid, wherein the electrical contact is produced by bending or folding of the stamped grid.

10. The contact element according to claim 1, characterized in that the contact element has a nickel layer, wherein the stannous surface coating (30) is deposited on the nickel layer.

11. The contact element according to claim 1, characterized in that the surface coating (30) is covered at least partially by a protective layer.

12. A method for producing a contact element according to claim 1, wherein tin and silver from an acidic solution are galvanically deposited on the contact element in order to form the surface coating (30).

13. The method according to claim 12, characterized in that the contact element is guided through a plurality of cells disposed in a row, wherein the cells are filled with methanesulfonic acid, in which tin ions and silver are ions are dissolved, and wherein the cell contents are circulated in the cell during electroplating.

14. The method according to claim 12, characterized in that the contact element in the cells (200) is subjected to the flow of methanesulfonic acid, in which tin ions and silver ions are dissolved, by means of nozzles (260).

15. The method according to claim 12, characterized in that the contact element is part of a strip-shaped stamped grid which is moved through the cells (200).

16. The contact element according to claim 1, characterized in that the contact section (12, 16, 18) is designed to produce an electrical contact by means of at least one of the following: insulation displacement terminations; a spring contact; crimping; flanging; riveting; screwing; caulking; folding; bending; inserting and press fitting.

17. The contact element according to claim 1, characterized in that the surface coating (30) is covered at least partially by a lubricant layer.

18. A method for producing a contact element according to claim 1, wherein tin and silver from a methanesulfonic acid solution are galvanically deposited on the contact element in order to form the surface coating (30).
